(19) United States
(12) Patent Application Publication
(10) Pub. No.: US 2019/0012413 A1
(43) Pub. Date: Jan. 10, 2019

(54) STATE CLASSIFYING METHOD, STATE CLASSIFYING DEVICE, AND RECORDING MEDIUM

(71) Applicant: FUJITSU LIMITED, Kawasaki-shi (JP)

(72) Inventors: Masaru TODORIKI, Kita (JP); Yuhei UMEDA, Kawasaki (JP); Ken KOBAYASHI, Satagaya (JP)

(73) Assignee: FUJITSU LIMITED, Kawasaki-shi (JP)

(21) Appl. No.: 16/027,961

(22) Filed: Jul. 5, 2018

(30) Foreign Application Priority Data
Jul. 7, 2017 (JP) 2017-133559

(51) Int. Cl. G06F 17/50

(52) U.S. Cl. CPC G06F 17/5009; G06F 2217/16

(57) ABSTRACT

A non-transitory computer-readable recording medium stores therein a state classifying program that causes a computer to execute a process including: generating an attractor containing a plurality of points that correspond to a plurality of sets of time series data, coordinate values of each of the plurality of points being values corresponding to the sets of time series data; generating Betti number sequence data by applying a persistent homology process on the attractor; and classifying a state that is represented by the plurality of sets of time series data based on the Betti number sequence data.

### CROSS-REFERENCE TO RELATED APPLICATION

This application is based upon and claims the benefit of priority of the prior Japanese Patent Application No. 2017-133559, filed on Jul. 7, 2017, the entire contents of which are incorporated herein by reference.

### FIELD

The embodiments discussed herein are related to a state classifying technique.

### BACKGROUND

Identifying the states of an object based on multidimensional time series data is practiced generally.

For example, in invariant analysis, a universal relationship (referred to as invariant) is extracted from multidimensional time series data that is collected by sensors, etc., and occurrence of an abnormal condition is sensed based on the extracted universal relationship.

In a subspace method, an orthogonal basis of a subspace representing features by low dimensionality is generated in each condition from the multidimensional time series data and, based on the similarity between the orthogonal basis and the input multidimensional time series data, the state that is represented by the input multidimensional time series data is classified.

The aforementioned invariant analysis and subspace method will be complemented briefly.

The invariant analysis is a method of monitoring the time correlation of multidimensional time series data to sense appearance of a change in part of the time series as a change of the correlation. For example, assume that, in a normal state, the correlation like that illustrated in FIG. 1 is obtained. When a change appears in the value of a variable z due to some kind of factor, the correlation like that illustrated in FIG. 2 is obtained from multidimensional time series data that is input and a change is sensed from the change of the correlation between a variable y and the variable z.

The invariant analysis can be practiced easily. Meanwhile, when all the variables change in the same direction simultaneously, sensing a change by the invariant analysis is difficult. For example, when all the variables change in the same direction simultaneously, a correlation like that illustrated in FIG. 3 may be obtained. In this case, as the difference from the correlation illustrated in FIG. 1 is not significant and thus the change is not sensed.

The subspace method is a method of generating a sub time series by a time-delay method from the 1-dimensional time series data and sensing a change of the condition of the whole space from the orientation and size of the orthogonal basis in the subspace that is defined by the sub time series. FIGS. 4 and 5 are diagrams to describe the sub space method. In FIGS. 4 and 5, the hatched oval represents a space to which sample points belong. In FIG. 4, σ1 denotes the size of the space to which sample points belong in a direction Z1, σ2 denotes the size in a direction Z2, and σ3 denotes the size in a direction Z3. Assume that the space to which the sample points belong varies as illustrated in FIG. 5. In FIG. 5, σ1 denotes the size of the space to which the sample points belong in the direction Y1, ρ2 denotes the size in the direction Y2, and ρ3 denotes the size in the direction Y3. From the change of the direction and size of the orthogonal basis, it is possible to sense a change in the time series data.

The subspace method is a linear analysis method and thus is suitable for a time series with robust linearity and periodicity. Furthermore, the subspace method enables detection of change of the subspace in density. On the other hand, in a case of a non-linear time series (such as a chaos time series), the orthogonal basis differs locally and it is difficult to determine an orthogonal basis that is stable over the space. Thus, a non-linear time series is not suitable to sensing of change by the subspace method.

There is however multidimensional time series data that is not suitable to the above-described analysis method. Analysis performed on such multidimensional time series data by the above-described analysis method may cause false classification of a state. The properties of multidimensional time series data can be checked in advance in order to select an appropriate analysis method; however, even if the properties are classified, no appropriate method may be found and furthermore the work to check the properties is not necessarily easy.

Patent Document 1: International Publication Pamphlet No. WO 2013/145493

### SUMMARY

According to an aspect of the embodiments, a non-transitory computer-readable recording medium stores therein a state classifying program that causes a computer to execute a process including: generating an attractor containing a plurality of points that correspond to a plurality of sets of time series data, coordinate values of each of the plurality of points being values corresponding to the sets of time series data; generating Betti number sequence data by applying a persistent homology process on the attractor; and classifying a state that is represented by the plurality of sets of time series data based on the Betti number sequence data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an invariant analysis;

FIG. 2 is a diagram for explaining the invariant analysis;

FIG. 3 is a diagram for explaining the invariant analysis;

FIG. 4 is a diagram for explaining a subspace method;

FIG. 5 is a diagram for explaining the subspace method;

FIG. 6 is a functional block diagram of an information processing device;

FIG. 7 is a diagram illustrating an exemplary graph of multidimensional time series data that is stored in time series data storage;

FIG. 8 is a chart illustrating a process flow of processes that are executed by the information processing device of a first embodiment;

FIG. 9 is a diagram illustrating an exemplary attractor;

FIG. 10 is a diagram illustrating an exemplary barcode chart;

FIG. 11 is a table illustrating exemplary barcode data;

FIG. 12 is a diagram for explaining a relationship between barcode data and Betti number sequence to be generated;

FIGS. 13A and 13B are diagrams illustrating exemplary barcode data;

FIG. 14 is a diagram illustrating exemplary data that is stored in a Betti number data storage;

FIGS. 15A and 15B are diagrams illustrating exemplary data that is stored in a distance data storage;

FIG. 16 is a diagram illustrating exemplary data that is stored in a sensing data storage in the first embodiment;

FIG. 17 is a diagram illustrating exemplary multidimensional time series data;

FIG. 18 is a diagram illustrating an exemplary attractor that is generated from data in the period before a change among the multidimensional time series data;

FIG. 19 is a diagram illustrating an exemplary attractor that is generated from data in the period after the change among the multidimensional time series data;

FIG. 20 is a diagram in which the attractor that is generated from the data in the period before the change and the attractor that is generated from the data in the period after the change are superimposed;

FIG. 21 is a diagram illustrating a Betti number sequence that is generated from the attractor of the period before the change and a Betti number sequence that is generated from the attractor of the period after the change;

FIG. 22 is a diagram illustrating Betti numbers at a radius that is a specific value;

FIG. 23 is a diagram illustrating a result of executing an invariant analysis;

FIG. 24 is a diagram illustrating the result of executing the invariant analysis;

FIG. 25 is a diagram illustrating the result of executing the invariant analysis;

FIG. 26 is a diagram illustrating a result of executing the subspace method;

FIG. 27 is a diagram illustrating exemplary multidimensional time series data;

FIG. 28 is a diagram illustrating an exemplary attractor that is generated from data in a period before a change among the multidimensional time series data;

FIG. 29 is a diagram illustrating the exemplary attractor that is generated from the data in the period before the change among the multidimensional time series data;

FIG. 30 is a diagram illustrating an exemplary attractor that is generated from the data in the period after the change among the multidimensional time series data;

FIG. 31 is a diagram illustrating the exemplary attractor that is generated from the data in the period after the change among the multidimensional time series data;

FIG. 32 is a diagram in which the attractor that is generated from the data in the period before the change and the attractor that is generated from the data in the period after the change are superimposed

FIG. 33 is a diagram illustrating a Betti number sequence that is generated from the attractor of the period before the change and the attractor of the period after the change;

FIG. 34 is a diagram illustrating Betti numbers at a radius that is a specific value;

FIG. 35 is a diagram illustrating a result of executing an invariant analysis;

FIG. 36 is a diagram illustrating a result of executing the subspace method;

FIG. 37 is a chart illustrating a process flow of processes that are executed by an information processing device of a second embodiment;

FIG. 38 is a diagram illustrating exemplary data that is stored in a sensing data storage in the second embodiment; and

FIG. 39 is a functional block diagram of a computer.

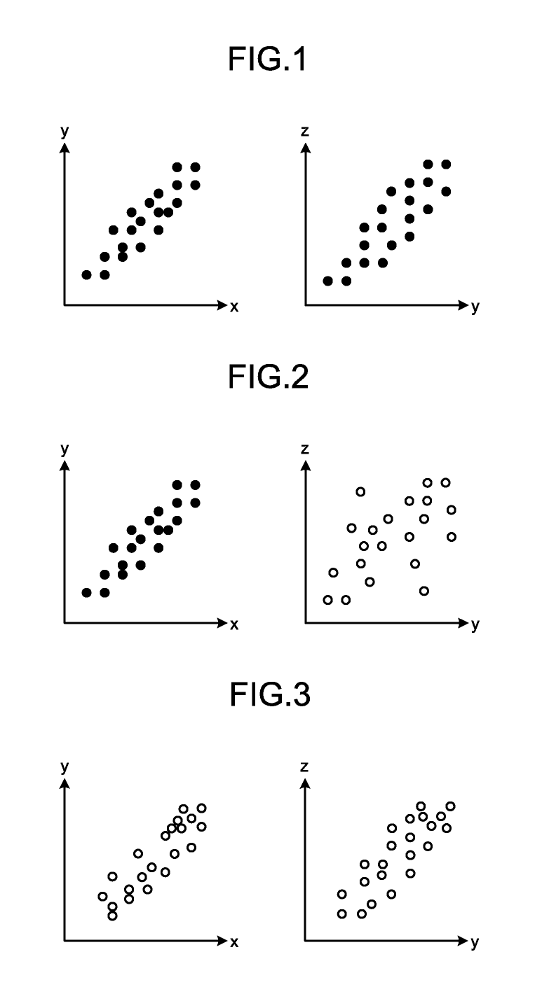

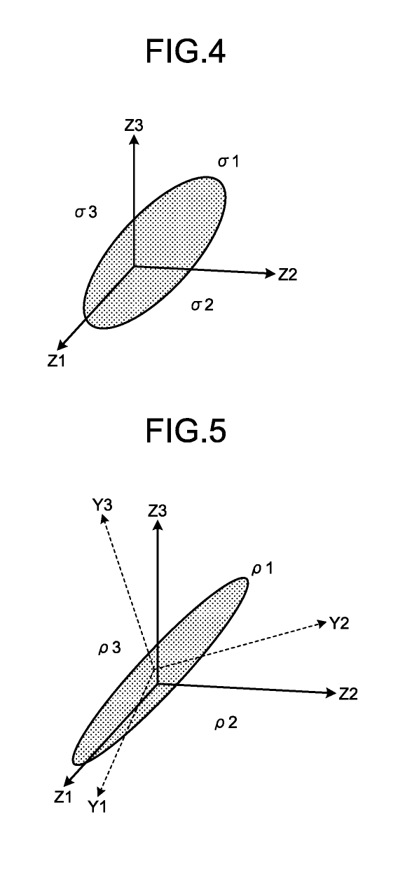

### DESCRIPTION OF EMBODIMENTS

Preferred embodiments will be explained with reference to accompanying drawings. The present disclosure is not limited by these embodiments.

### First Embodiment

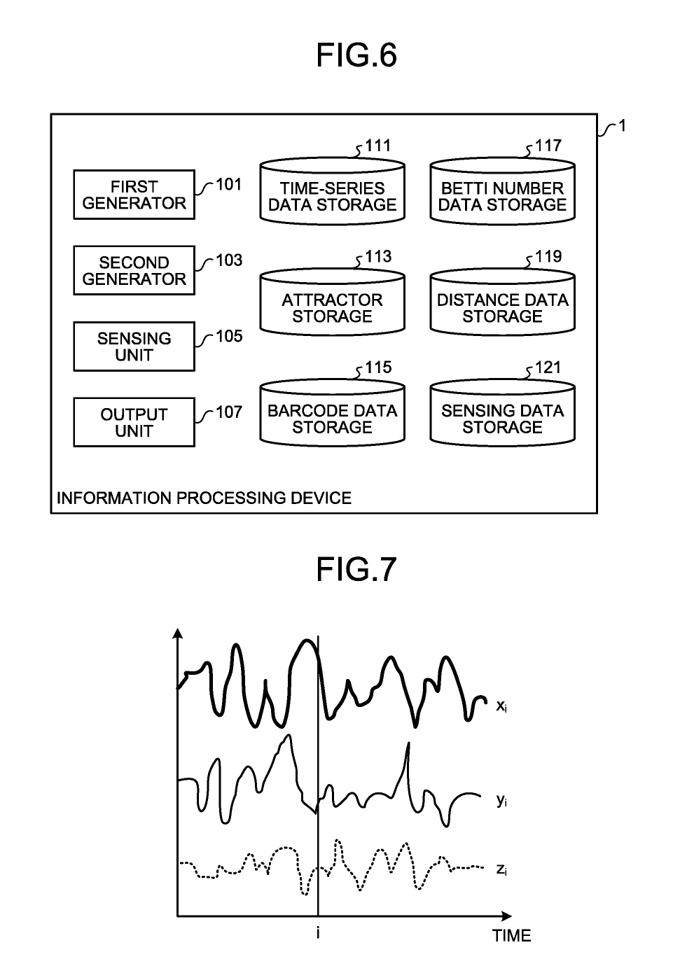

FIG. 6 is a functional block diagram of an information processing device 1 of a first embodiment. The information processing device 1 includes a first generator 101, a second generator 103, a sensing unit 105, an output unit 107, a time series data storage 111, an attractor storage 113, a barcode data storage 115, a Betti number data storage 117, a distance data storage 119 and a sensing data storage 121.

The first generator 101, the second generator 103, the sensing unit 105 and the output unit 107 are realized by a central processing unit (CPU) 2503 in FIG. 39 by executing a program that is loaded into a memory 2501 in FIG. 39. The time series data storage 111, the attractor storage 113, the barcode data storage 115, the Betti number data storage 117, the distance data storage 119 and the sensing data storage 121 are, for example, provided in the memory 2501 or a hard disk drive (HDD) 2505 in FIG. 39.

The first generator 101 executes a process based on multidimensional time series data that is stored in the time series data storage 111 and stores the result of the process in the attractor storage 113. The second generator 103 executes a process based on the data that is stored in the attractor storage 113 and stores the result of the process in the barcode data storage 115. The second generator 103 executes a process based on the data that is stored in the barcode data storage 115 and stores the result of the process in the Betti number data storage 117. The sensing unit 105 executes a process based on the data that is stored in the distance data storage 119 and stores the result of the process in the sensing data storage 121. The output unit 107 displays display data that is generated based on the data stored in the sensing data storage 121 on a display device (such as a monitor). The multidimensional time series data in the first embodiment refers to time series data on multiple items.

FIG. 7 is a diagram illustrating an exemplary graph of multidimensional time series data that is stored in the time series data storage 111. FIG. 7 represents a graph about the time and value with respect to each item of three-dimensional time series data, where xᵢ denotes the value of item x at time i, yᵢ denotes the value of item y at time i, and zᵢ denotes the value of item z at time i. The time series data is, for example, biological data (time series data of the heart rate, brain waves, pulses, body temperature, or the like), data that is measured by sensors (time series data of a gyro sensor, acceleration sensor, geomagnetic sensor, or the like), financial data (time series data of interest, commodity prices, balance of international payments, stock prices, or the like), natural environment data (time series data of temperature, humidity, carbon dioxide concentration or the like) or social data (data of labor statistics, population statistics, or the like).

In the first embodiment, the multidimensional time series data like that illustrated in FIG. 7 is dealt with and the state represented by the multidimensional time series data is classified. In the example in FIG. 7, the number of dimensions is 3. Alternatively, the number of dimensions may be 2 or 4.

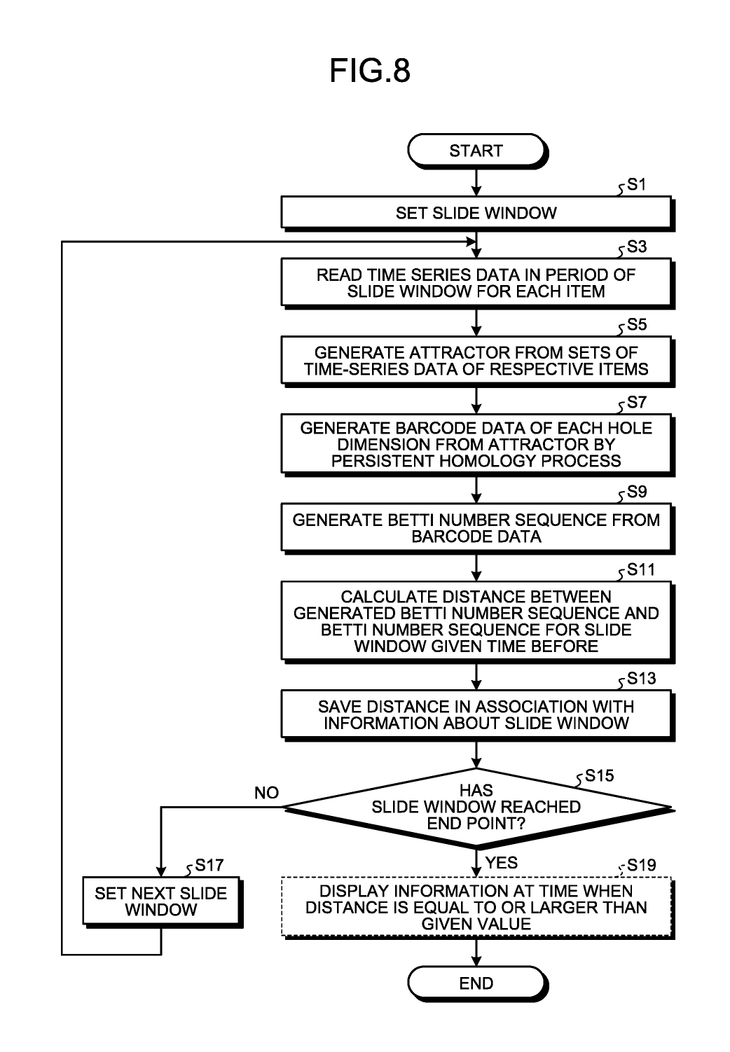

The processes that are executed by the information processing device 1 in the first embodiment will be described. FIG. 8 is a diagram illustrating a process flow of the processes that are executed by the information processing device 1 in the first embodiment.

The first generator 101 sets a slide window (FIG. 8: step S1). A slide window refers to a period during which multidimensional time series data to be processed is extracted. At step S1, a time at which an initial slide window starts and a length of period are set.

The first generator 101 reads the multidimensional time series data in the period of the slide window from the time series data storage 111 for each item (step S3).

The first generator 101 generates an attractor that is a set of (xᵢ, yᵢ and zᵢ) in the period of the slide window from the time series data on each item that is read at step S3 (step S5). The first generator 101 then stores the generated attractor in the attractor storage 113. A set of a finite number of points that is generated at step S5 is not an “attractor” strictly but a quasi-attractor; however, the set of points that is generated at step S5 is referred to as “attractor” herein. When the time series data on each item is acquired at discrete times, an attractor may be generated not from a set of all (xᵢ, yᵢ and zᵢ) in the period of the slide window but a set containing (xᵢ, yᵢ and zᵢ) at n intervals (n=1, 2, 3, . . . ).

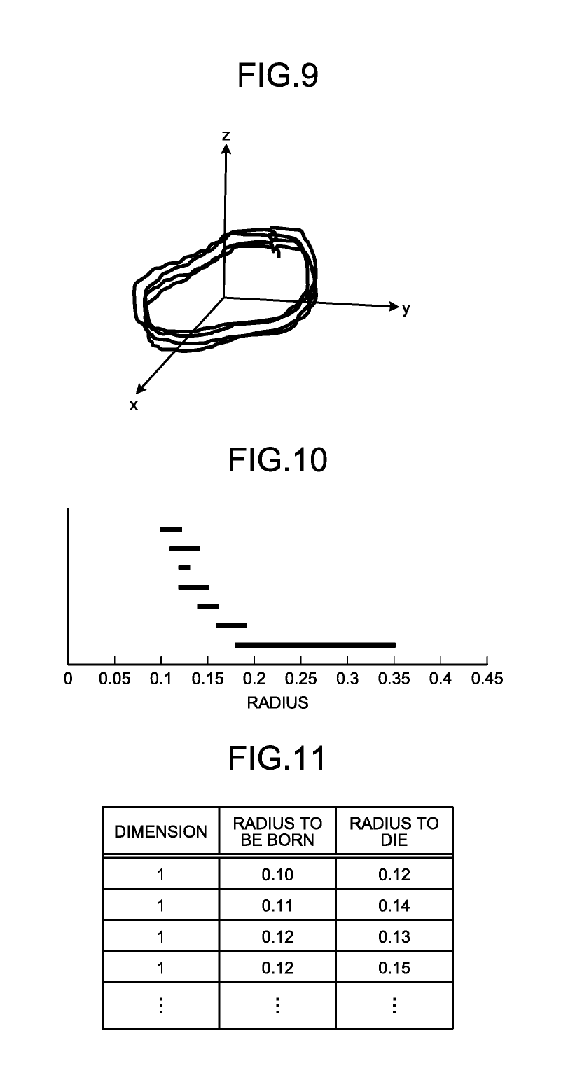

FIG. 9 is a diagram illustrating an exemplary attractor. In the example in FIG. 9, the attractor is represented in a three-dimensional space. An attractor reflects features of the original multidimensional time series data and an analogous relationship among attractors is equivalent to an analogous relationship among sets of original multidimensional time series data. When an attractor is analogous to another attractor, this means that the sets of features of the respective sets of original multidimensional time series data are analogous to each other. Attractors that are analogous to each other are generated from sets of multidimensional data that have the same features but are different from each other in phenomenon (appearance). From sets of multidimensional time series data each of which has different features but are analogous to each other in phenomenon, different attractors are generated.

Returning to the description of FIG. 8, the second generator 103 performs a persistent homology process on the attractor that is generated at step S5 to generate barcode data of each hole dimension (step S7). The second generator 103 stores the generated barcode data in the barcode data storage 115. The barcode data of each hole dimension is generated at step S7. Alternatively, barcode data of only a given hole dimension (for example, 0 dimension) may be generated.

The “homology” refers to a method of expressing features of an object by the number of holes in m (m≥0) dimensions. A “hole” refers to an element in a homology group and a 0-dimensional hole is a cluster, a 1-dimensional hole is a hole (tunnel), and a 2-dimensional hole is a void. The number of holes of each dimension is referred to as a Betti number.

“Persistent homology” is a method for featuring transition of m-dimensional holes in an object (a set of points herein) and persistent homology makes it possible to find features related to arrangement of points. In this method, each point in an object is gradually expanded into a sphere and, in that process, a time at which each hole is born (expressed by a radius of a sphere at birth) and a time at which each hole dies (expressed by a radius of a sphere at death) are classified. Note that the “time” at which a hole is born, the “time” at which the hole dies are not relevant to “time” in the multidimensional time series data from which the attract to be processed by persistent homology is generated.

Using birth radii and death radii of holes, it is possible to generate a barcode chart like that illustrated in FIG. 10. In FIG. 10, a value along the horizontal axis represented a radius and each line segment corresponds to one hole. The radius that corresponds to the left end of a line segment is a birth radius of a hole and the radius that corresponds to the right end of the line segment is a death radius of the hole. A line segment is referred to as a persistent interval. Such a barcode chart represents that, when a radius is 0.18, for example, there are two holes.

FIG. 11 is a table illustrating exemplary data for generating a barcode chart (referred to as barcode data below). The exemplary data in FIG. 11 contains numeric values each representing a hole dimension, birth radii of the holes and death radii of the holes. In step S7, barcode data is generated for each hole dimension.

Execution of the above-described process enables equivalence between the analogous relationship between barcode data that is generated from an attractor and barcode data that is generated from another attractor and the analogous relationship between the attractors. Thus, when the attractors are the same, sets of barcode data to be generated are the same and, when the attractors are not the same, a difference appears between the sets of barcode data except when the difference between the attractors is slight.

For the details of persistent homology, refer to “Yasuaki Hiraoka, ‘Protein Structure and Topology: Introduction to Persistent Homology’, Kyoritsu Shuppan”, for example.

Returning to the description of FIG. 8, the second generator 103 reads the barcode data that is generated at step S7 from the barcode data storage 115 and generates a Betti number sequence from the read barcode data (step S9). The second generator 103 then stores the generated Betti number sequence in the Betti number data storage 117.

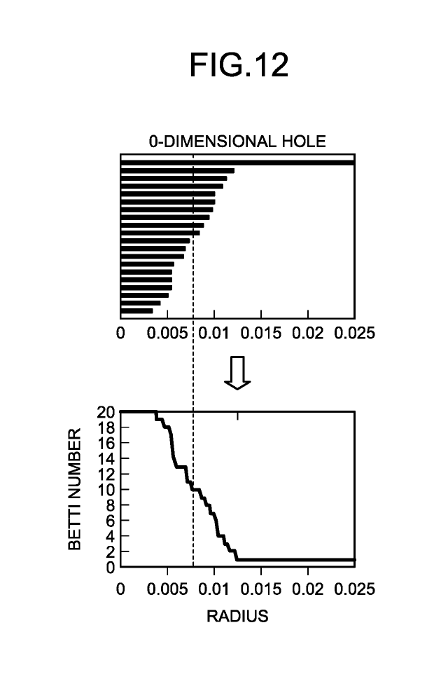

The Betti number sequence that is generated at step S9 is data representing the relationship between the radius of spheres in persistent homology (interval between the time at which a hole is born and the time at which the hole dies) and the Betti number. The relationship between barcode data and a generated Betti number sequence will be described using FIG. 12. FIG. 12 is a diagram for explaining a relationship between barcode data and a Betti number sequence for 0-dimensional holes. The upper graph in FIG. 12 is a graph that is generated from barcode data, where the values along the horizontal axis represent radii. The lower graph in FIG. 12 is a graph that is generated from a Betti number sequence, where the values along the vertical axis represent Betti numbers and the values along the horizontal axis represent radii. The Betti number represents the number of holes and thus, for example, as illustrated in FIG. 12, the number of holes that exist when the radius corresponds to the dashed line in the upper graph is 10 and accordingly, in the lower graph, the Betti number corresponding to the dashed line is also 10.

Basically, the same Betti number sequence is obtained from the same barcode data. In other words, when original attractors are the same, the same Betti number sequences are obtained; however, a case where the same Betti number sequences are obtained from different barcodes occurs rarely.

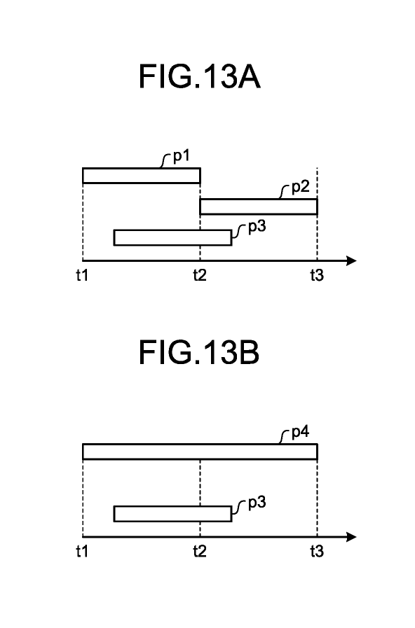

For example, assume barcode data like that illustrated in FIGS. 13A and 13B. In the case in FIG. 13A, persistent interval p1 starts at time t1 and ends at time t2, and persistent interval p2 starts at time t2 and ends at time t3. On the other hand, in the case in FIG. 13B, persistent interval p4 starts at time t1 and ends at time t3. In both cases, persistent intervals p3 are completely the same.

In such a case, completely the same Betti number sequences are obtained from the barcode data in both cases, and thus it is not possible to distinguish between both cases by the Betti number sequences; however, a possibility that such a phenomenon will occur is low.

Therefore, an analogous relationship between a Betti number sequence that is generated from certain barcode data and a Betti number sequence that is generated from other barcode data is equivalent to an analogous relationship between sets of barcode data as long as the above-described rare case does not occur. Accordingly, even though the definition of distance between data changes, an analogous relationship between Betti number sequences that are generated from barcode data is mostly equivalent to the analogous relationship between sets of original multidimensional time series data.

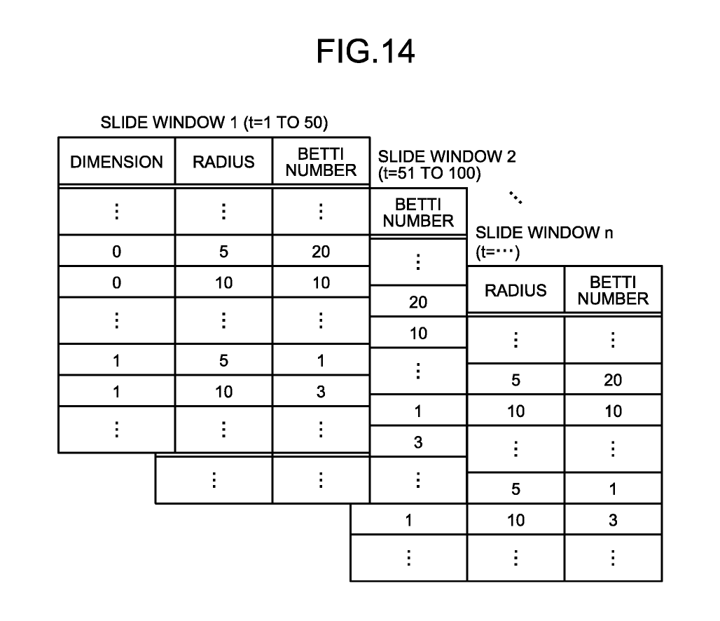

FIG. 14 is a diagram illustrating exemplary data that is stored in the Betti number data storage 117. In the example in FIG. 14, data containing dimensions, radii and Betti numbers is stored for each slide window and the Betti number sequences of each hole dimension are linked. Note that, at step S7, when barcode data of only a given hole dimension is generated, a Betti number sequence for the given hole dimension is stored for each slide window.

As described above, execution of the persistent homology process enables the Betti number sequence to reflect features of the original multidimensional time series data. A Betti number sequence is generated for each slide window and is stored in the Betti number data storage 117.

Calculation for persistent homology is a topological method and has been used for analysis of a structure of a static object that is represented by a set of points (for example, protein, a molecular crystal, a sensor network or the like). On the other hand, in the first embodiment, a set of points (that is, an attractor) that expresses features of data that continuously change over time is a target of calculation. In the first embodiment, analyzing the structure of a set of points itself is not a purpose and thus the target and purpose are completely different from those of typical calculation of persistent homology.

Returning to the description of FIG. 8, the second generator 103 reads the Betti number sequence that is generated at step S9 from the Betti number data storage 117. The second generator 103 then calculates a distance between the read Betti number sequence and a reference Betti number sequence (a Betti number sequence that is generated for a slide window a given time before) (step S11). The slide window the given time before is a slide window where a time the given time before the time at which the slide window for which the Betti number sequence is generated at step S9 starts (for example, a slide window one slide window before). When there is no Betti number sequence for the slide window the given time before (for example, when the process at step S11 is executed for the first time), the distance from a Betti number sequence that is generated in advance is calculated or step S11 is omitted. The distance is, for example, an Euclidean distance (or norm) and a cosine analogy, or the like.

The second generator 103 saves the distance that is calculated at step S11 in association with the information about the slide window for which the Betti number sequence is generated at step S9 (step S13).

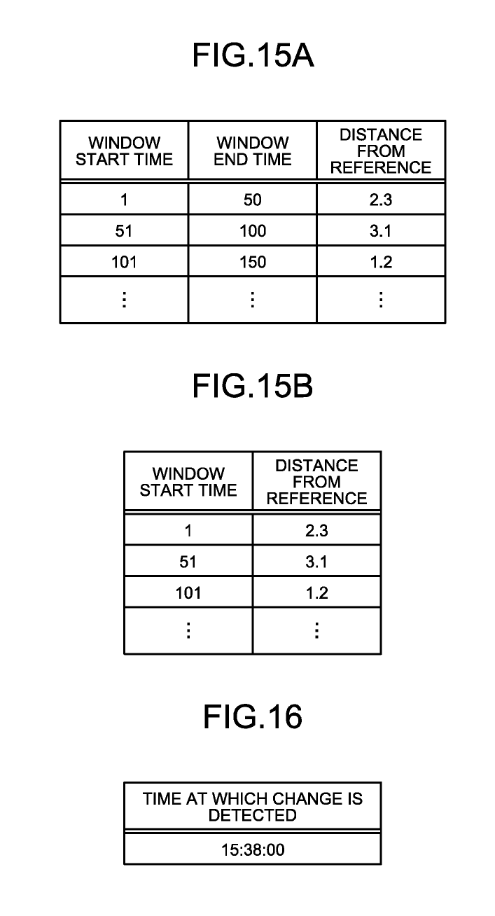

FIGS. 15A and 15B are diagrams illustrating exemplary data that is stored in the distance data storage 119. In the example in FIG. 15A, times at each of which a slide window starts, times at each of which the slide window ends and distances each from a reference Betti number sequence are stored. In the example in FIG. 15B, times at each of which a slide window starts and distances each from a reference Betti number sequence are stored.

The second generator 103 determines whether the slide window has reached the end point (i.e., whether the time at which the period of the slide window that is set at step S1 or step S17 ends has reached the time at which the multidimensional time series data ends) (step S15).

When the slide window has not reached the end point (step S15: No route), the second generator 103 sets the next slide window (step S17). For example, the next slide window is set such that the time a given time after the time at which the slide window, which is set at step S1 or the previous step S17, starts is the time at which the period of the next slide window starts. Note that a setting may be made such that the sequential slide windows have overlapping periods. The process then returns to step S3.

On the other hand, when the slide window has reaches the end point (step S15: YES route), the sensing unit 105 stores information of a time of the slide window for which the distance that is calculated at step S11 is equal to or larger than a given value (for example, a start time, an intermediate time or an end time) in the sensing data storage 121. The output unit 107 then generates display data based on the information of the time that is stored in the sensing data storage 121 and displays the generated display data on the display device (step S19). Then, the process ends. Whether to execute the process at S19 is a choice and thus the block of step S19 is indicated by a dashed line in FIG. 8.

FIG. 16 is a diagram illustrating exemplary data that is stored in the sensing data storage 121 in the first embodiment. In the first embodiment, as a change can be sensed according to a distance, the information of time that is stored in the sensing data storage 121 represents the time at which a change is sensed.

The sensing of change in the first embodiment does not limit multidimensional time series data to which the sensing is applicable, not as in the related technology that is represented in the column of background art (for example, the invariant analysis or the subspace method), and the sensing of the first embodiment is applicable to more types of multidimensional time series data. In other words, it is possible to appropriately sense a change in multidimensional time series data with a possibility that false sensing may occur when the related technology is used and thus improve accuracy of sensing a change.

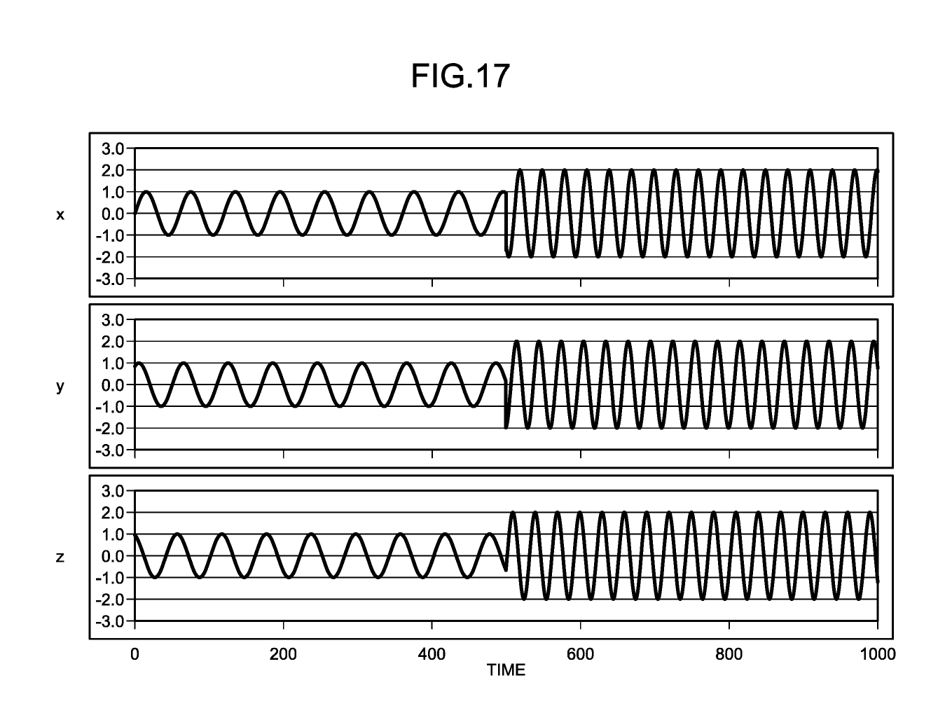

This aspect will be described below using specific examples. The multidimensional time series data illustrated in FIG. 17 will be exemplified. In FIG. 17, the values along the horizontal axis represent times and values along the vertical axis represent values of time series data. In the example in FIG. 17, time series data of item x, time series data of item y and time series data of item z are represented and the time series data of any of the items is sine-wave data but each set of time series data has a given phase shift. At time 500, a change is made to change the amplitude from 1 to 2 and increase the frequency.

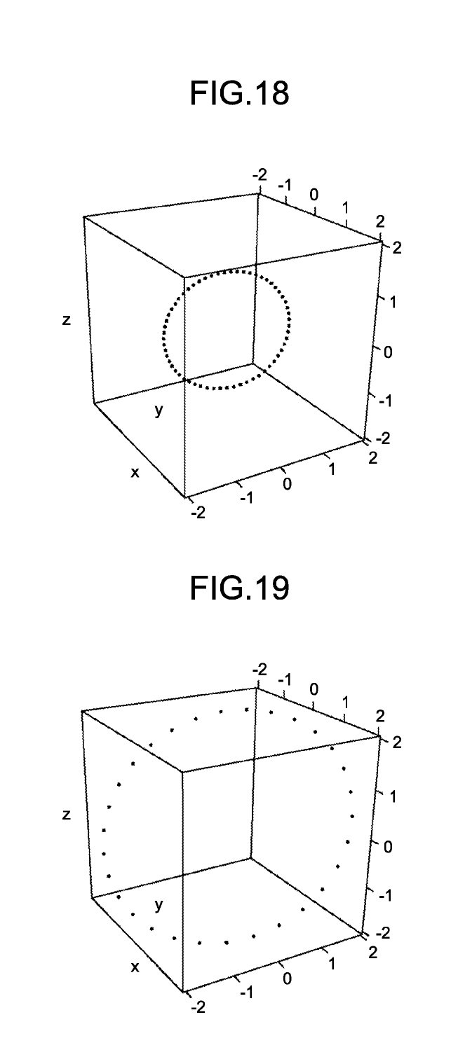

FIG. 18 is a diagram illustrating an exemplary attractor that is generated from data in a period before the change among the multidimensional time series data illustrated in FIG. 17. In the example in FIG. 18, points each at coordinates that are values at each time are represented in a three-dimensional space.

FIG. 19 is a diagram illustrating an exemplary attractor that is generated from data in a period after the change among the multidimensional time series data illustrated in FIG. 17. As in FIG. 18, points each at coordinates that are values at each time are represented in a three-dimensional space.

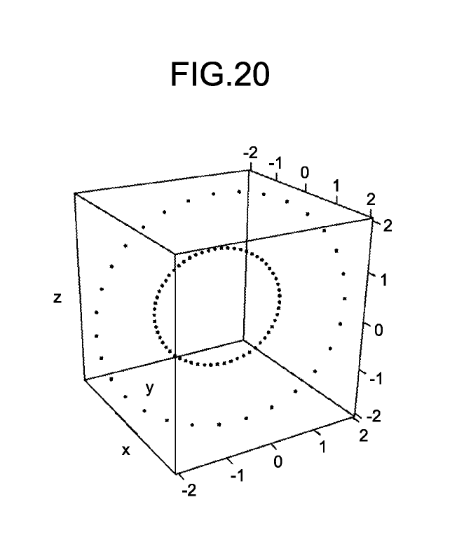

FIG. 20 is a diagram in which the attractor that is generated from the data in the period before the change and the attractor that is generated from the data in the period after the change are superimposed. As is obvious from FIG. 20, before and after the change, the shape of the attractor is the same but the size of the attractor changes. Furthermore, the change in frequency leads to a sparse distribution of points.

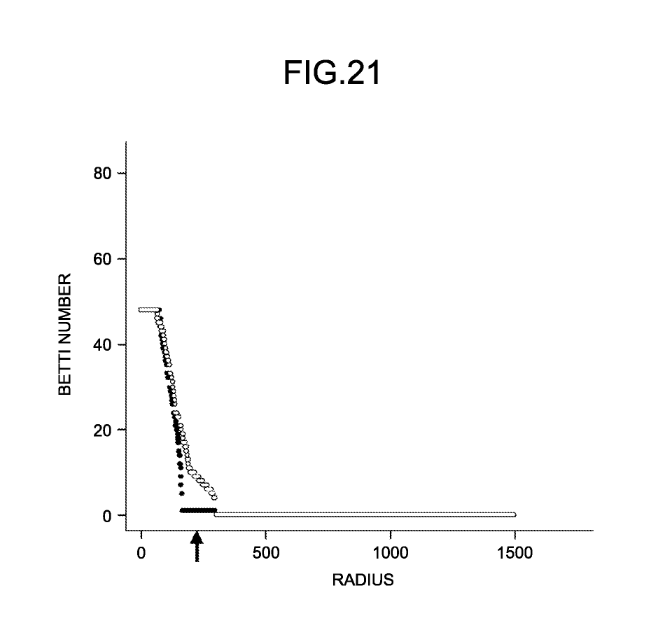

FIG. 21 is a diagram illustrating a Betti number sequence that is generated from the attractor of the period before the change and a Betti number sequence that is generated from the attractor of the period after the change. In FIG. 21, the hatched plot represents the Betti number sequence that is generated from the attractor of the period before the change and the unhatched plot represents the Betti number sequence that is generated from the attractor of the period after change. As FIG. 21 represents, the change of the attractor in size changes the shape of the Betti number sequence.

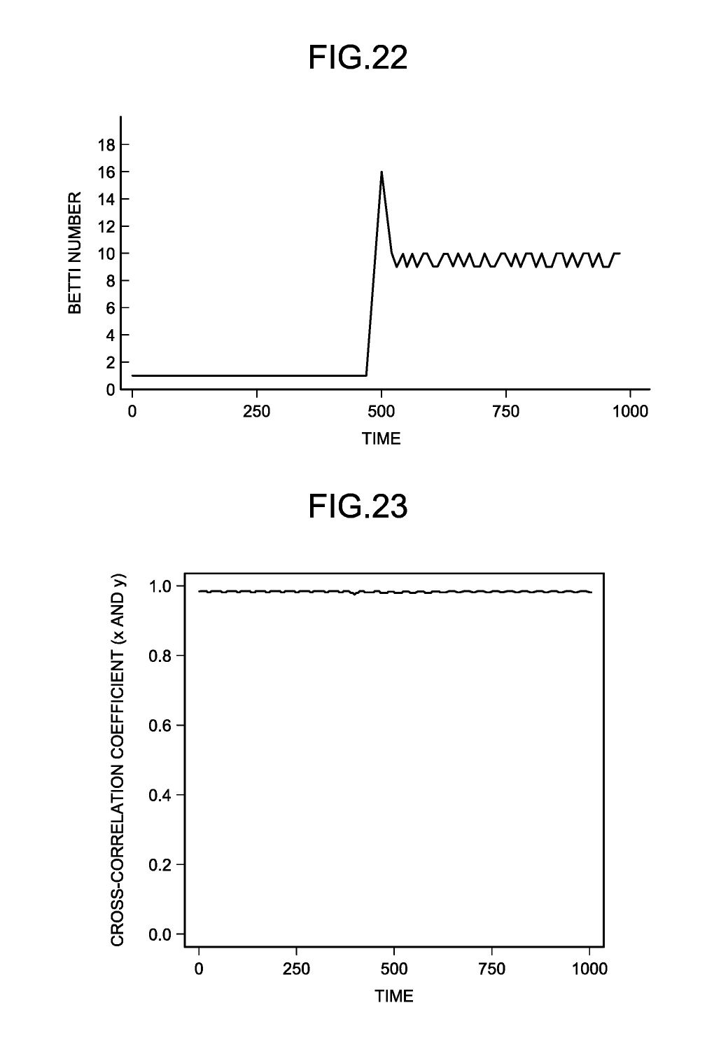

FIG. 22 is a diagram illustrating the Betti number at the radius indicated by the arrow in FIG. 21. At time 500, the Betti number changes from 1 to 16. As described above, at a time when a change occurs in multidimensional time series data, an obvious change appears also in Betti number.

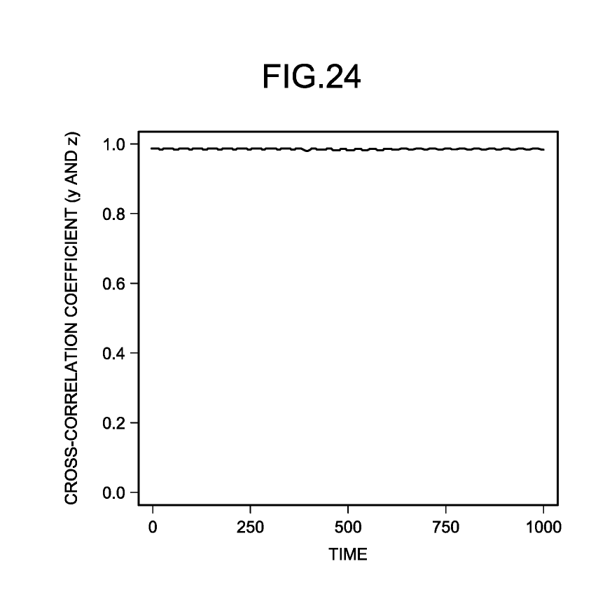

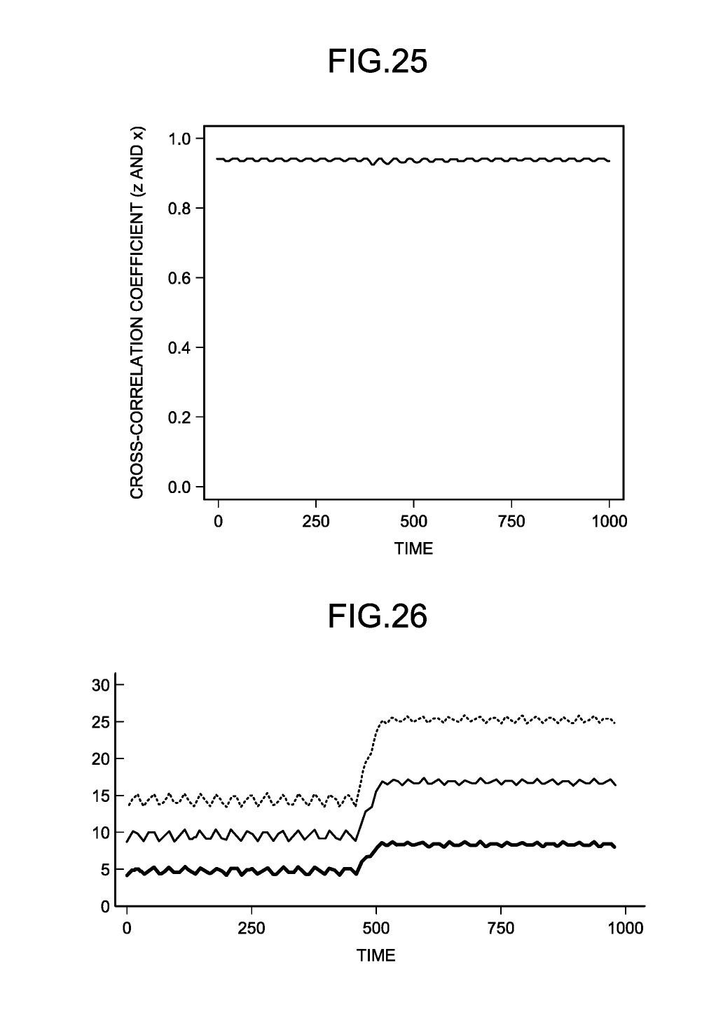

FIGS. 23 to 25 represent the result of executing an invariant analysis on the multidimensional time series data represented in FIG. 17. In FIG. 23, the values along the horizontal axis represent times and the values along the vertical axis represent cross-correlation coefficients between item x and item y. In FIG. 24, the values along the horizontal axis represent times and the values along the vertical axis represent cross-correlation coefficients each between item y and item z. In FIG. 25, the values along the horizontal axis represent times and the values along the vertical axis represent cross-correlation coefficients between item z and item z. As illustrated in FIGS. 23 to 25, the cross-correlation coefficient transitions at approximately 1 in any of the combinations and thus it is not possible to sense a change at time 500.

FIG. 26 is a diagram illustrating a result of executing the subspace method on the multidimensional time series data illustrated in FIG. 7. In FIG. 26, the values along the horizontal axis represent times, and the values along the vertical axis represent amounts corresponding to the position and size of each subspace. Specifically, the values represent distances each from a reference point of condition point in each subspace. As the reference point, for example, the center of distribution is usable. In FIG. 26, the bold solid line represents the value of item x, the narrow solid line represents the value of item y and the dashed line represents the value of item z. A bias is applied to make it possible to easily check a change in the value of each of the items. As illustrated in FIG. 26, the values along the vertical axis after the change have values larger than those before the change. This is because an increase in frequency increases the interval between points on the attractor and thus, when a sub time series is created using the same number of condition points, the subspace is increased. As described above, the values change at around time 500 and accordingly it is possible to sense a change in condition.

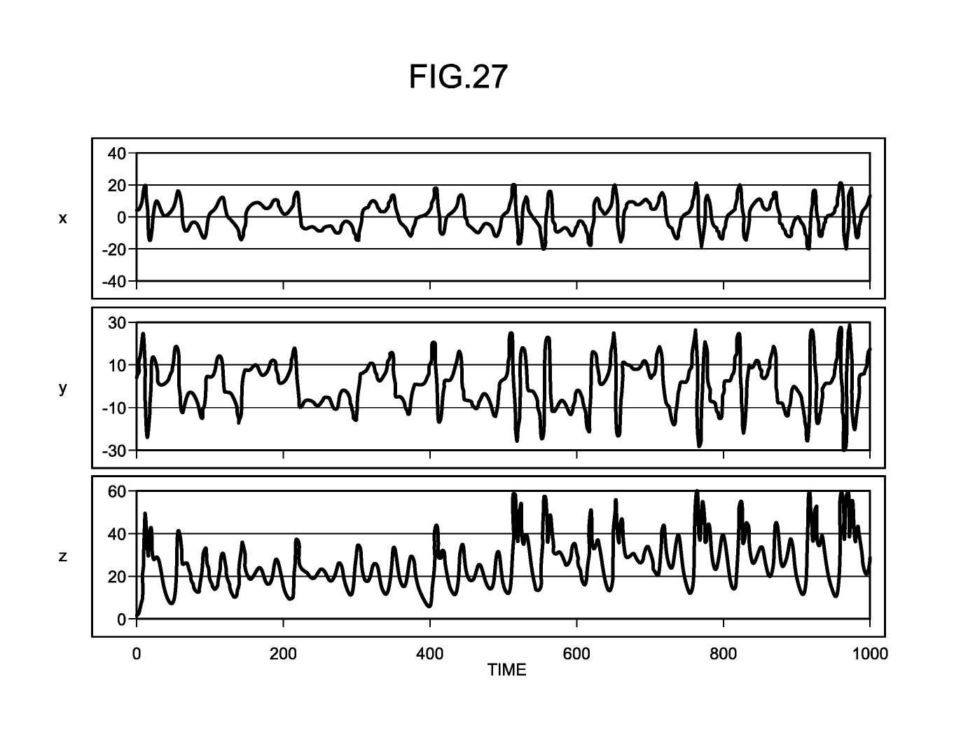

Using another specific example, a difference between a result of using the method of the first embodiment and a result of using the related technology will be described. The multidimensional time series data illustrated in FIG. 27 will be exemplified. In FIG. 27, the values along the horizontal axis represent times and the values along the vertical axis represent values of time series data. In the example in FIG. 27, time series data of item x, time series data of item y and time series data of item z are represented and x, y and z correspond to three variables contained in a governing equation of a chaotic time series. At time 500, the value of a control parameter of the governing equation is changed. Note that the condition of double scroll chaos is mostly saved at around the change.

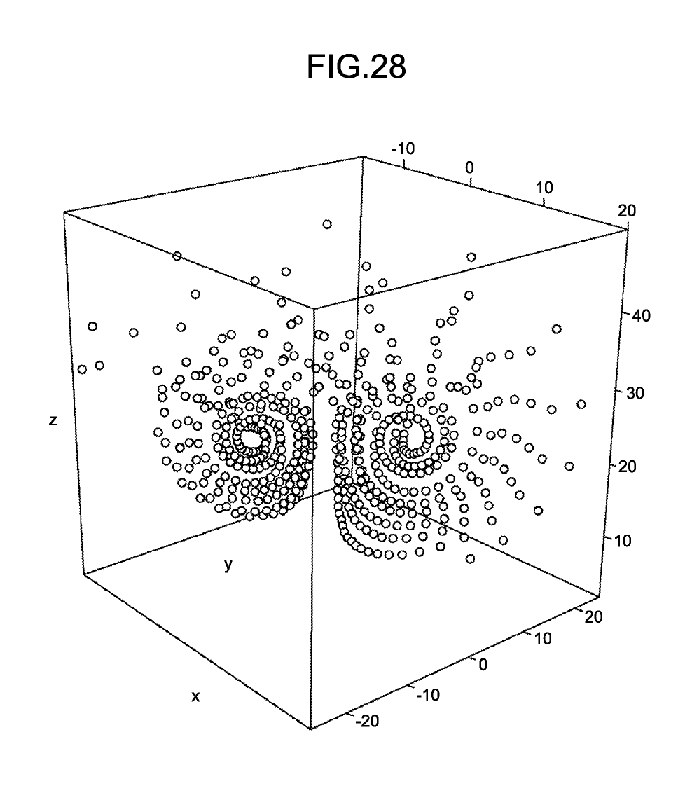

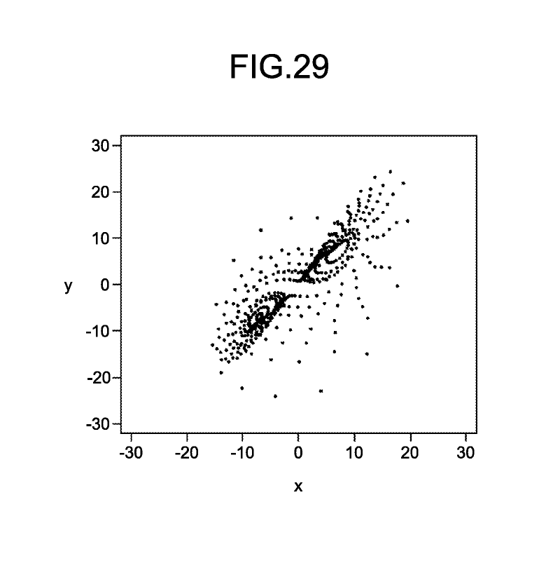

FIGS. 28 and 29 are diagrams illustrating an exemplary attractor that is generated from the data in a period before a change among the multidimensional time series data illustrated in FIG. 27. In the example in FIG. 28, points each at coordinates that are values at each time are represented in a three-dimensional space. In the example in FIG. 29, points each at coordinates that are values at each time are represented in an x-y plane.

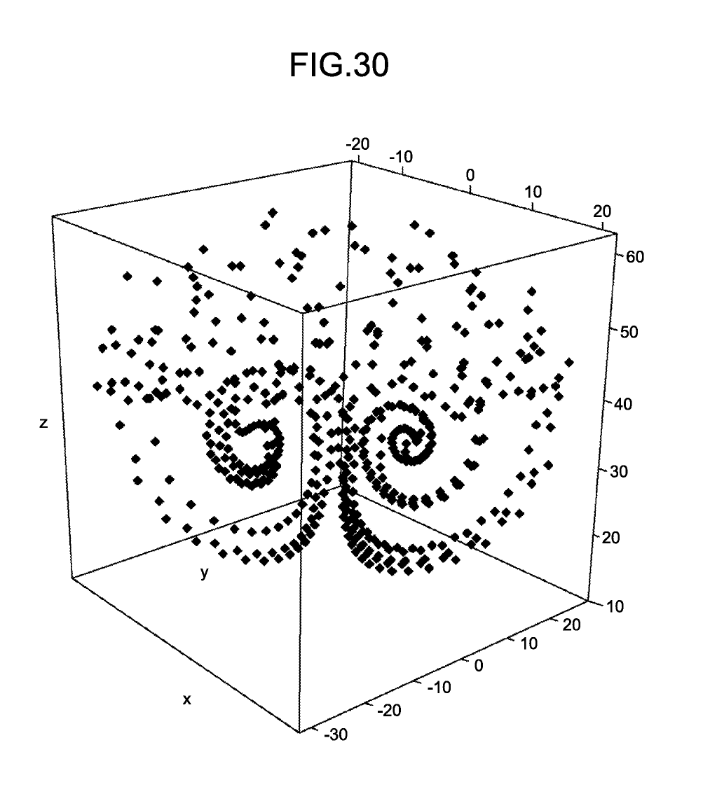

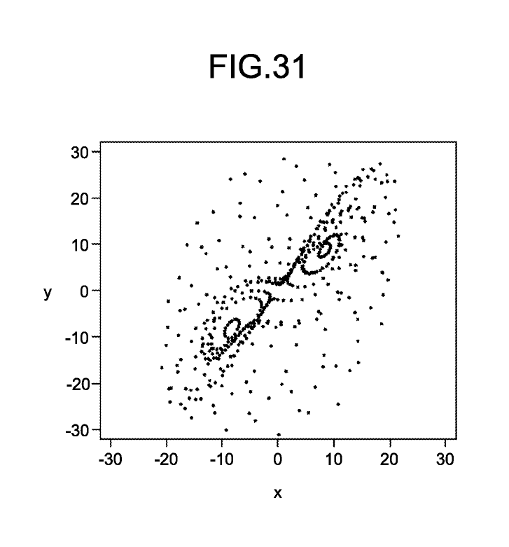

FIGS. 30 and 31 are diagrams illustrating an exemplary attractor that is generated from the data in a period after the change among the multidimensional time series data illustrated in FIG. 27. In the example illustrated in FIG. 30, points each at coordinates that are values at each time are represented in a three-dimensional space. In the example in FIG. 31, points each at coordinates that are values at each time are represented in an x-y plane.

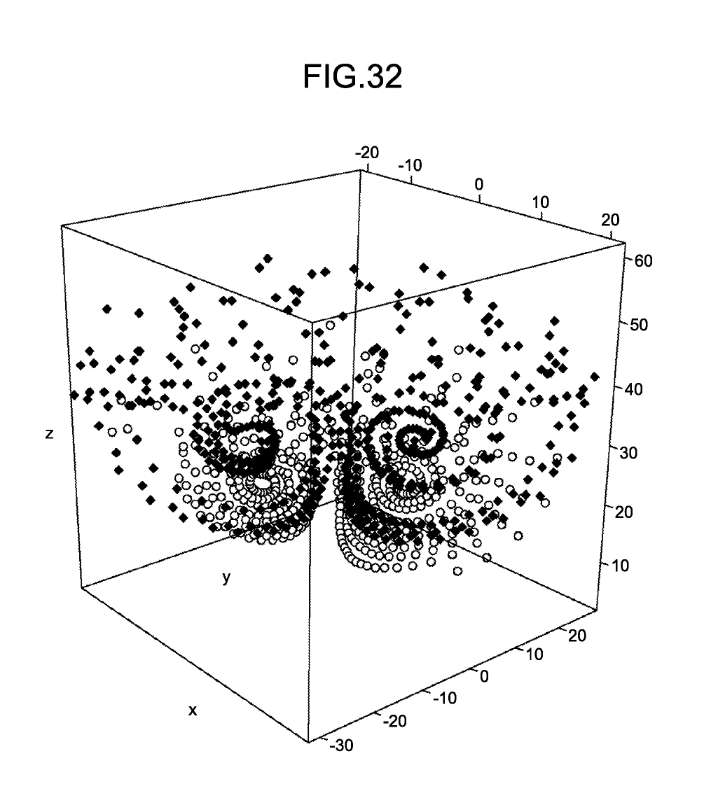

FIG. 32 is a diagram in which the attractor that is generated from the data in the period before the change and the attractor that is generated from the data in the period after the change are superimposed. As is obvious from FIG. 32, the double scroll shape is common before and after the change but the shape is different in detail before and after the change.

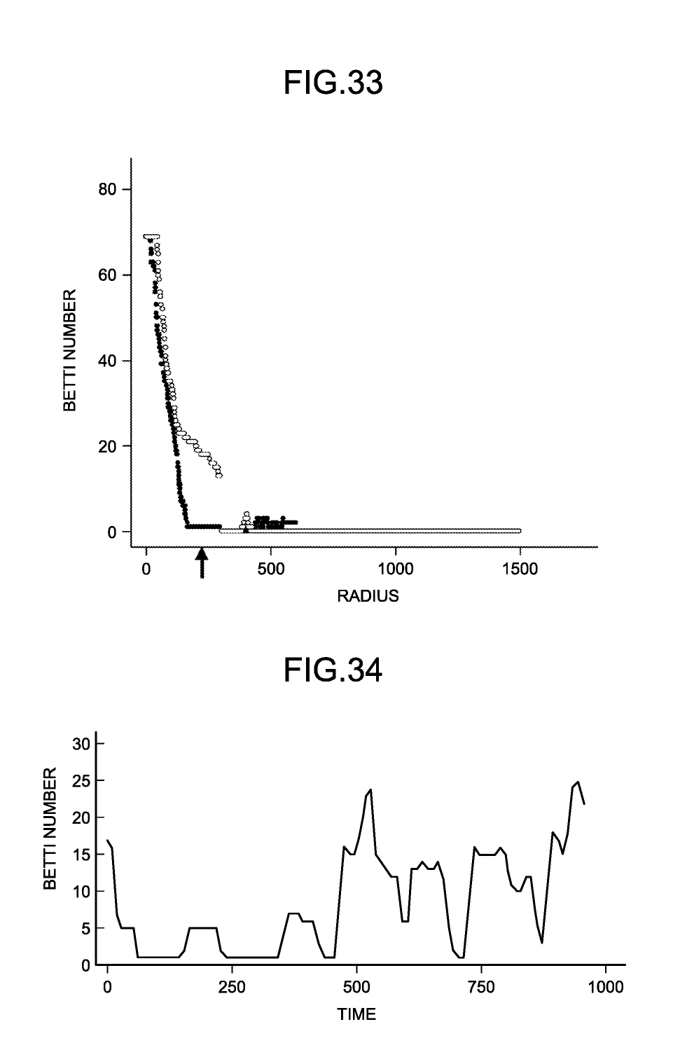

FIG. 33 a diagram illustrating a Betti number sequence that is generated from the attractor of the period before the change and a Betti number sequence that is generated from the attractor of the period after change. In FIG. 33, the hatched plot represents the Betti number sequence that is generated from the attractor of the period before the change and the unhatched plot represents the Betti number sequence that is generated from the attractor of the period after change. As FIG. 33 represents, the change of the attractor in shape changes the shape of the Betti number sequence.

FIG. 34 is a diagram illustrating the Betti number at the radius indicated by the arrow in FIG. 33. The change of the Betti number at time 500 is large and the value of Betti number and mode of transition before the change in value of the control parameter and those after the change are different from each other. As described above, at a time when a change occurs in multidimensional time series data, an obvious change appears in Betti number.

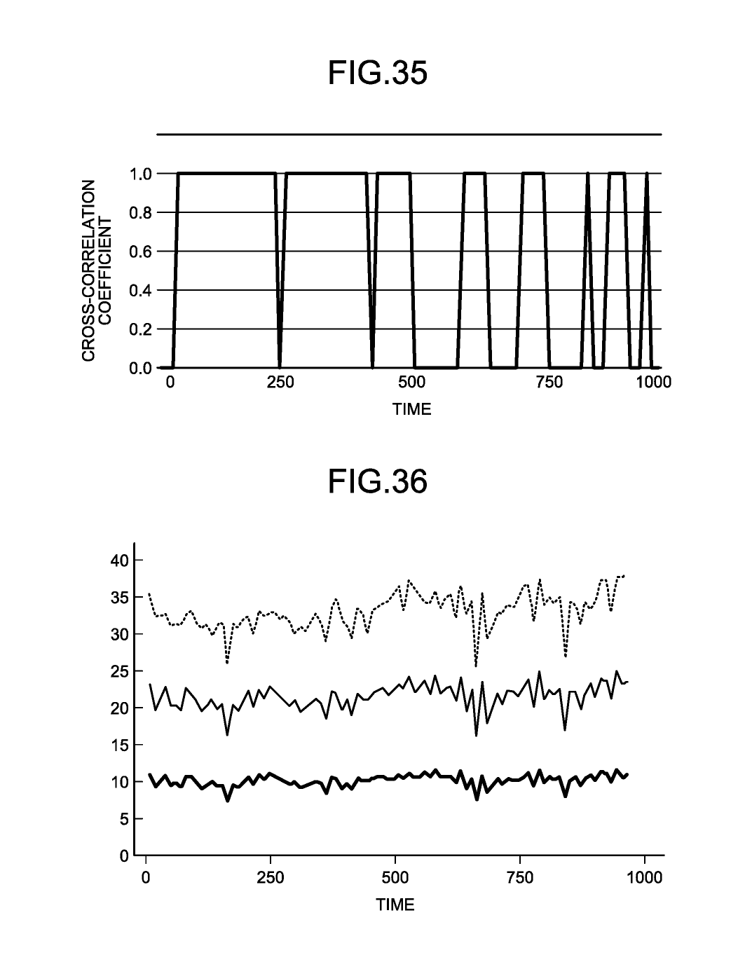

FIG. 35 represents the result of executing an invariant analysis on the multidimensional time series data represented in FIG. 27. In FIG. 35, the values along the horizontal axis represent times and the values along the vertical axis represent cross-correlation coefficients each between any one of combinations of variables. As illustrated in FIG. 35, after the control parameter is changed, the period during which the value of cross-correlation coefficient is 0 is longer than that before the change of the control parameter. Accordingly, it is possible to sense a change in condition from a difference between the values of the cross-correlation coefficient before and after the change of the control parameter.

FIG. 36 is a diagram illustrating a result of executing the subspace method on the multidimensional time series data illustrated in FIG. 27. In FIG. 36, the values along the horizontal axis represent times. The values along the vertical axis represent amounts corresponding to the position and size of each subspace. Specifically, the values represent distances each from a reference point of condition point in each subspace. As the reference point, for example, the center of distribution is usable. In FIG. 36, the bold solid line represents the value of item x, the narrow solid line represents the value of item y and the dashed line represents the value of item z. A bias is applied to make it possible to easily check a change in the value of each of the items. As illustrated in FIG. 36, the change in value at around the change is small and time series data is non-liner data in the first place, and thus it is difficult to extract a stable orthogonal basis. The method is sensitive to change of subspaces and thus there seems to be a change in detail locally; however, it is difficult to sense the change clearly. Thus, the subspace method is not suitable to the multidimensional time series data illustrated in FIG. 27.

The sensing of change in the first embodiment does not limit multidimensional time series data to which the sensing is applicable, not as in the related technology that is represented in the column of background art, and the sensing of the first embodiment is applicable to more types of multidimensional time series data.

### Second Embodiment

Sensing of change is executed as a mode of classifying a state in the first embodiment. In a second embodiment, sensing of abnormality is executed as another mode of classifying a state.

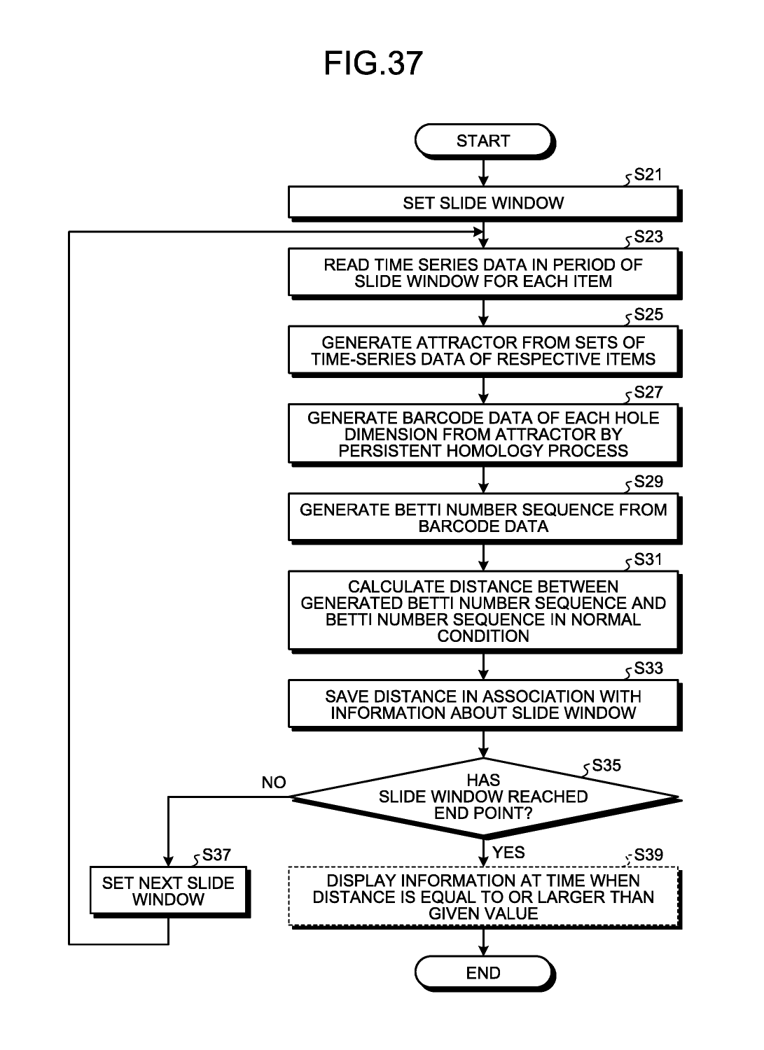

Processes that are executed by the information processing device 1 according to the second embodiment will be described. FIG. 37 is a diagram illustrating a process flow of the processes that are executed by the information processing device 1 in the second embodiment.

The first generator 101 sets a slide window (FIG. 37: step S21). A slide window refers to a period during which multidimensional time series data to be processed is extracted. At step S21, a time at which and initial slide window and a length of period are set.

The first generator 101 reads the multidimensional time series data in the period of the slide window from the time series data storage 111 for each item (step S23).

The first generator 101 generates an attractor that is a set of (xᵢ, yᵢ and zᵢ) in the period of the slide window from the time series data on each item that is read at step S23 (step S25). The first generator 101 then stores the generated attractor in the attractor storage 113.

The second generator 103 performs a persistent homology process on the attractor that is generated at step S25 to generate barcode data of each hole dimension (step S27). The second generator 103 stores the generated barcode data in the barcode data storage 115. The barcode data of each hole dimension is generated at step S27. Alternatively, barcode data of only a given hole dimension (for example, 0 dimension) may be generated.

The second generator 103 reads the barcode data that is generated at step S27 from the barcode data storage 115 and generates a Betti number sequence from the read barcode data (step S29). The second generator 103 then stores the generated Betti number sequence in the Betti number data storage 117.

The second generator 103 reads the Betti number sequence that is generated at step S29 from the Betti number data storage 117. The second generator 103 then calculates a distance between the read Betti number sequence and a reference Betti number sequence (a Betti number sequence that is generated for a slide window in a normal condition) (step S31). The Betti number sequence for the slide window in the normal condition is generated in advance. The distance is, for example, a Euclidean distance (or norm) and a cosine analogy, or the like.

The second generator 103 saves the distance that is calculated at step S31 in association with the information about the slide window for which the Betti number sequence is generated at step S29 (step S33).

The second generator 103 determines whether the slide window has reached the end point (i.e., whether the time at which the period of slide window that is set at step S21 or step S37 ends has reached the time at which the multidimensional time series data ends) (step S35).

When the slide window has not reached the end point (step S35: No route), the second generator 103 sets the next slide window (step S37). For example, the next slide window is set such that the time a given time after the time at which the slide window, which is set at step S21 or the previous step S37, starts is the time at which the period of the next slide window starts. Note that a setting may be made such that the sequential slide windows have overlapping periods. The process then returns to step S23.

On the other hand, when the slide window has reached the end point (step S35: YES route), the sensing unit 105 stores information of a time of the slide window for which the distance that is calculated t step S31 is equal to or larger than a given value (for example, a start time, an intermediate time or an end time) in the sensing data storage 121. The output unit 107 then generates display data based on the information of the time that is stored in the sensing data storage 121 and displays the generated display data on the display device (step S39). Then, the process ends. Whether to execute the process at S39 is a choice and thus the block of step S39 is indicated by a dashed line in FIG. 37.

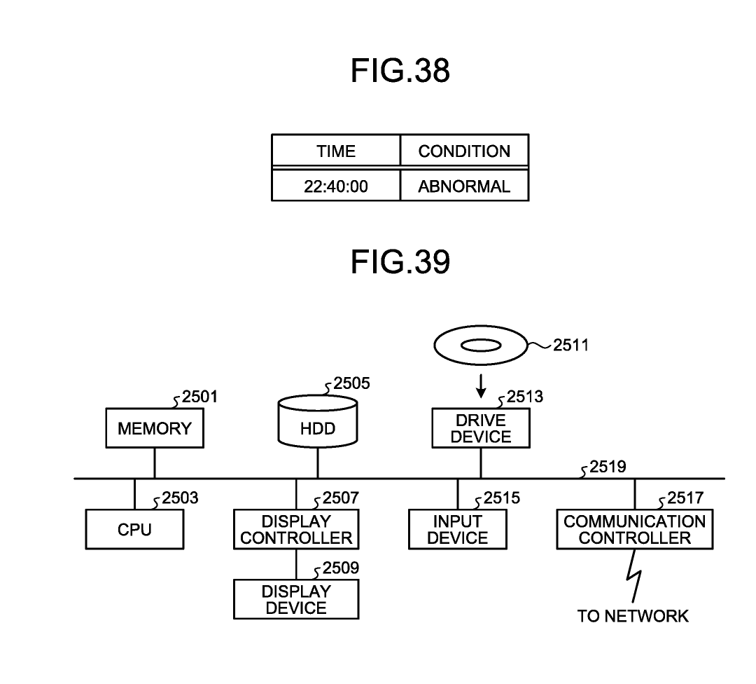

FIG. 38 is a diagram illustrating exemplary data that is stored in the sensing data storage 121 in the second embodiment. In the second embodiment, as a difference from the reference condition can be sensed according to a distance, the information of time that is stored in the sensing data storage 121 represents the time at which the difference from the reference condition is sensed. In the example in FIG. 38, as the difference from the normal condition that serves as the reference condition is sensed, information indicating that an abnormal condition occurred is stored.

The sensing of change in the second embodiment does not limit multidimensional time series data to which the sensing is applicable, not as in the related technology that is represented in the column of background art (for example, the invariant analysis or the subspace method), and the sensing of the first embodiment is applicable to more types of multidimensional time series data. In other words, it is possible to appropriately sense a change in multidimensional time series data with a possibility that false sensing may occur when the related technology is used and thus improve accuracy of sensing a change.

The embodiments of the invention have been described above; however the present invention is not limited thereto. For example, the functional block configuration of the information processing device 1 described above may mismatch an actual program module configuration.

The configuration of each table described above is an example only and the above-described configuration need not necessarily be used. In the process flow, the turns of the processes may be switched as long as the process result does not change. Furthermore, the processes may be executed in parallel.

Furthermore, multiple information processing devices may be caused to execute the processes of the embodiments to increase the speed of the processes.

The above-described information processing device 1 is computer device. As illustrated in FIG. 39, the memory 2501, the CPU 2503, the HDD 2505, a display controller 2507 connected to a display device 2509, a drive device 2513 for a removable disk 2511, an input unit 2515, and a communication controller 2517 for connection with a network are connected via a bus 2519. An operating system (OS) and an application program for carrying out the processes in the embodiments are stored in the HDD 2505, and, when executed by the CPU 2503, the OS and the application program are read from the HDD 2505 into the memory 2501. The CPU 2503 controls the display controller 2507, the communication controller 2517, and the drive device 2513 according to the content of the processes of the application program and causes them to perform predetermined operations. Moreover, data being processed is stored in the memory 2501 mainly. Alternatively, the data may be stored in the HDD 2505. In the embodiments of the invention, the application program to perform the above-described processes is stored in the computer-readable removable disk 2511 and distributed and is installed into the HDD 2505 from the drive device 2513. The application program may be installed into the HDD 2505 via a network, such as the Internet, and the communication controller 2517. In the above-described computer device, the hardware, such as the CPU 2503 and the memory 2501, the OS and the program, such as the application program, organically cooperate with each other, so that various functions described above are realized.

The above-described embodiments are summarized as follows.

A state classifying method according to the first embodiment includes: (A) generating an attractor containing multiple points each at coordinates that are values of multiple sets of time series data; (B) generating Betti number sequence data by applying a persistent homology process on the attractor; and (C) classifying a state that is represented by the multiple sets of time series data based on the Betti number sequence data.

The Betti number sequence data that is generated according to the above-described method reflects the features of original multiple sets of time series data and thus accuracy of classifying a state can be improved.

The persistent homology process may be a process of counting a Betti number in a case the radii of spheres each centering each point contained in the attractor are increased over time.

Increasing the radii of the spheres changes the number of holes, and the change of the number of holes differs depending on the distribution of the points contained in the attractor. Accordingly, counting the Betti number in the above-described manner enables the Betti number sequence data to properly reflect the features of the attractor.

The classifying the state represented by the multiple sets of time series data may include (c1) sensing a change in the state represented by the multiple sets of time series data based on comparison between the generated Betti number sequence data and Betti number sequence data that is generated for multiple sets of time series data a given time before.

Accordingly, sensing a change can be executed appropriately.

The classifying the state represented by the multiple sets of time series data may include (c2) sensing that the state represented by the multiple sets of time series data is abnormal based on comparison between the generated Betti number sequence data and Betti number sequence data in a case where the state represented by the multiple sets of time series data is normal.

Note that, based on comparison with a Betti number in the case where the state is abnormal, it may be sensed that the state represented by the multiple sets of time series data is normal.

The state classifying method may further include (D) outputting information on the classified state represented by the multiple sets of time series data.

Accordingly, an operator of the computer, or the like, is able to check the state.

The generating the attractor may include (a2) generating points each at coordinates that are the values extracted from the multiple sets of time series data, respectively, for each time and generating the attractor containing the generated points.

The state classifying device according to the second embodiment includes (E) a first generator (the first generator 101 of the embodiment is an example of the first generator) configured to generate an attractor containing multiple points each at coordinates that are values of multiple sets of time series data; (F) a second generator (the second generator 103 of the embodiment is an example of the second generator) configured to generate Betti number sequence data by applying a persistent homology process on the attractor; and (G) an classifying unit (the sensing unit 105 according to the embodiment is an example of the classifying unit) configured to classify a state represented by the multiple sets of time series data based on the Betti number sequence data.

It is possible to create a program for causing a computer to execute the processes according to the above-described method, and the program is stored in a computer readable storage medium or storage device, such as a flexible disk, a CD-ROM, a magneto-optic disk, a semiconductor memory, or a hard disk. In addition, the intermediate process result is temporarily stored in a storage device, such as a main memory.

According to an aspect, it is possible to improve accuracy of classifying a state based on multidimensional time series data.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein a state classifying program that causes a computer to execute a process comprising:
generating an attractor containing a plurality of points that correspond to a plurality of sets of time series data, coordinate values of each of the plurality of points being values corresponding to the sets of time series data;
generating Betti number sequence data by applying a persistent homology process on the attractor; and
classifying a state that is represented by the plurality of sets of time series data based on the Betti number sequence data.

2. The non-transitory computer-readable recording medium according to claim 1, wherein the persistent homology process is a process of counting a Betti number in a case where radii of spheres each centering each point contained in the attractor are increased over time.

3. The non-transitory computer-readable recording medium according to claim 1, wherein the classifying the state represented by the plurality of sets of time series data includes sensing a change in the state represented by the plurality of sets of time series data based on comparison between the generated Betti number sequence data and Betti number sequence data that is generated for the plurality of sets of time series data a given time before.

4. The non-transitory computer-readable recording medium according to claim 1, wherein the classifying the state represented by the plurality of sets of time series data includes sensing that the state represented by the plurality of sets of time series data is abnormal based on comparison between the generated Betti number sequence data and Betti number sequence data in a case where the state represented by the plurality of sets of time series data is normal.

5. The non-transitory computer-readable recording medium according to claim 1, wherein the process further includes outputting information on the classified state represented by the plurality of sets of time series data.

6. The non-transitory computer-readable recording medium according to claim 1, wherein the generating the attractor includes generating points each at coordinates that are the values extracted from the plurality of sets of time series data, respectively, for each time and generating the attractor containing the generated points.

7. A state classifying method comprising:
generating an attractor containing a plurality of points that correspond to a plurality of sets of time series data, coordinate values of each of the plurality of points being values corresponding to the sets of time series data;
generating Betti number sequence data by applying a persistent homology process on the attractor; and
classifying a state that is represented by the plurality of sets of time series data based on the Betti number sequence data, by a processor.

8. A state classifying device comprising:
a processor configured to:
generate an attractor containing a plurality of points that correspond to a plurality of sets of time series data, coordinate values of each of the plurality of points being values corresponding to the sets of time series data;
generate Betti number sequence data by applying a persistent homology process on the attractor; and
classify a state that is represented by the plurality of sets of time series data based on the Betti number sequence data.
